(19) United States
(12) Patent Application Publication
(10) Pub. No.: US 2010/0274601 A1
(43) Pub. Date: Oct. 28, 2010

(54) SUPPLY CHAIN PERAMETER OPTIMIZATION AND ANOMALY IDENTIFICATION IN PRODUCT OFFERINGS

(75) Inventors: Derek P. Bagwell, Rochester, MN (US); Ivory Wellman Knipfer, Rochester, MN (US); William Robert Taylor, Rochester, MN (US); Cheranellore Vasudevan, Austin, TX (US)

Correspondence Address: IBM CORP (YA);C/O YEE & ASSOCIATES PC, P.O. BOX 802333, DALLAS, TX, 75380, US

(73) Assignee: Intermational Business Machines Corporation, Armonk, NY (US)

(21) Appl. No.: 12/429,726

(22) Filed: Apr. 24, 2009

(51) Int. Cl. G06Q 10/00; G06Q 30/00

(52) U.S. Cl. 705/7; 705/1.1

(57) ABSTRACT

An illustrative embodiment of a computer-implemented method for maintaining a product offering suite, identifies a subset of proposals from a proposal database maintained on a data processing system, using selected criteria stored on the data processing system, analyzes the subset of proposals using conformance criteria also stored on the data processing system to form an analyzed subset of proposals, and identifies a set of alert instances from the analyzed subset of proposals. The computer-implemented method further updates the product offering suite on the data processing system using information using the set of alert instances.

### BACKGROUND

1. Field

The present disclosure relates generally to an improved data processing system, and more particularly, to a computer-implemented method, an apparatus and a computer program product for supply chain parameter optimization and anomaly identification in product offerings.

2. Description of the Related Art

Companies typically create product offerings which they expect to sell in the marketplace. Volumes are forecasted for each product offering, and materials, processes, and labor resources are planned and allocated to support the expected product volumes. When the product offerings are not ordered in the expected volumes, or not ordered at all, a situation arises that may be referred to as “product offering bloat” in which unnecessary product offerings exist in a product offering repository, catalog or suite. The product offering suite is a set of product offering catalogs that may be implemented on a set of computer-implemented databases. The existence of the unnecessary product offerings may adversely impact many overhead, end-to-end costs for the companies.

At times, the customer demands may vary. Some product offerings may prove to be more popular while other offerings rarely, if ever, ordered. Examples of unnecessary costs tied to the offerings that are rarely or never ordered include creating the product announcements and marketing materials, setting up the offerings in the ordering tools, testing, planning resources, inventory, and related impact on information technology systems performance.

Intangible costs, such as customer confusion in the marketplace, are also present due to the product offering bloat, which cause delays in making decisions to place orders for products. Typically, knowledge of the performance of the product offerings in the marketplace at the earliest possible time is advantageous. Having such knowledge on a timely basis allows appropriate remedial measures to be taken in time.

Efforts to increase the accuracy of forecasts based on past order history have been shown to be prone to error because the information is often very late in the product life cycle. Use of history-based planning to establish a life cycle management team and process to manage the product offering catalog only provides the team with historical data. Typically, the order data and history are not sufficient to accurately predict future product orders. Current product offering trimming or filtering based on the use of firm orders oftentimes also occurs too late in the process. This situation leads to cost overruns through wasted inventory. Therefore, a need is present for a method and apparatus to improve the relevance of product offerings.

### SUMMARY

According to one embodiment, a computer-implemented method for maintaining a product offering suite identifies a subset of proposals from a proposal database maintained on a data processing system using selected criteria stored on the data processing system, analyzes the subset of proposals using conformance criteria also stored on the data processing system to form an analyzed subset of proposals, and identifies a set of alert instances from the analyzed subset of proposals. The computer-implemented method further updates the product offering suite on the data processing system using information using the set of alert instances.

According to another embodiment, an apparatus for maintaining a product offering suite comprises a communication fabric, a storage device connected to the communication fabric, wherein the storage device stores computer-executable program code, a communications unit connected to the communication fabric, a display connected to the communication fabric, and a processor unit connected to the communication fabric. The processor unit executes the computer-executable program code to direct the apparatus to identify a subset of proposals from a proposal database using selected criteria, analyze the subset of proposals using conformance criteria to form an analyzed subset of proposals, identify a set of alert instances from the analyzed subset of proposals, and update the product offering suite using information using the set of alert instances.

According to another embodiment, a computer program product for maintaining a product offering suite comprises a computer-recordable storage media and computer-executable program code stored on the computer-recordable storage media for identifying a subset of proposals from a proposal database using selected criteria, computer-executable program code, stored on computer-recordable storage media, for analyzing the subset of proposals using conformance criteria to form an analyzed subset of proposals, computer-executable program code, stored on computer-recordable storage media, for identifying a set of alert instances from the analyzed subset of proposals, and computer-executable program code, stored on computer-recordable storage media, for updating the product offering suite using information using the set of alert instances.

According to another embodiment, a service for maintaining a product offering suite, identifies a subset of proposals from a proposal database maintained on a data processing system using selected criteria, and analyzes the subset of proposals using conformance criteria to form an analyzed subset of proposals. The service further identifies a set of alert instances from the analyzed subset of proposals, and updates the product offering suite on the data processing system using information using the set of alert instances, for a user.

### BRIEF DESCRIPTION OF THE SEVERAL VIEWS OF THE DRAWINGS

FIG. 1 is a block diagram of a data processing system in accordance with an embodiment;

FIG. 2 is a block diagram of an overview of a product offering management process, in accordance with an illustrative embodiment;

FIG. 3 is a tabular representation of a data structure containing filtering models for use with the product offering management process of FIG. 2, in accordance with an illustrative embodiment;

FIG. 4 is a tabular representation of a data structure containing compliance models for use with the product offering management process of FIG. 2, in accordance with an illustrative embodiment;

FIG. 5 is a flowchart of a high-level view of the product offering management process of FIG. 2, in accordance with an illustrative embodiment; and

FIG. 6 is a flowchart of a detail view of the product offering management process of FIG. 5, in accordance with an illustrative embodiment.

### DETAILED DESCRIPTION OF THE INVENTION

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer-usable or computer-readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by, or in connection with, the instruction execution system, apparatus, or device. The computer-usable medium may include a propagated data signal with the computer-usable program code embodied therewith, either in baseband or as part of a carrier wave. The computer-usable program code may be transmitted using any appropriate medium, including but not limited to wireless, wire line, optical fiber cable, RF, etc.

Computer program code for carrying out operations of the present invention may be written in any combination of one or more programming languages, including an object-oriented programming language such as Java, Smalltalk, C++ or the like, and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus, to produce a machine, such that the instructions, which execute via the processor of the computer, or other programmable data processing apparatus, create means for implementing the functions/acts specified in the flowchart and/or block diagram block or blocks. These computer program instructions may also be stored in a computer-readable medium that can direct a computer, or other programmable data processing apparatus, to function in a particular manner, such that the instructions stored in the computer-readable medium produce an article of manufacture including instruction means which implement the function/act specified in the flowchart and/or block diagram block or blocks.

The computer program instructions may also be loaded onto a computer, or other programmable data processing apparatus, to cause a series of operational steps to be performed on the computer, or other programmable apparatus, to produce a computer-implemented process such that the instructions which execute on the computer, or other programmable apparatus, provide processes for implementing the functions/acts specified in the flowchart and/or block diagram block or blocks.

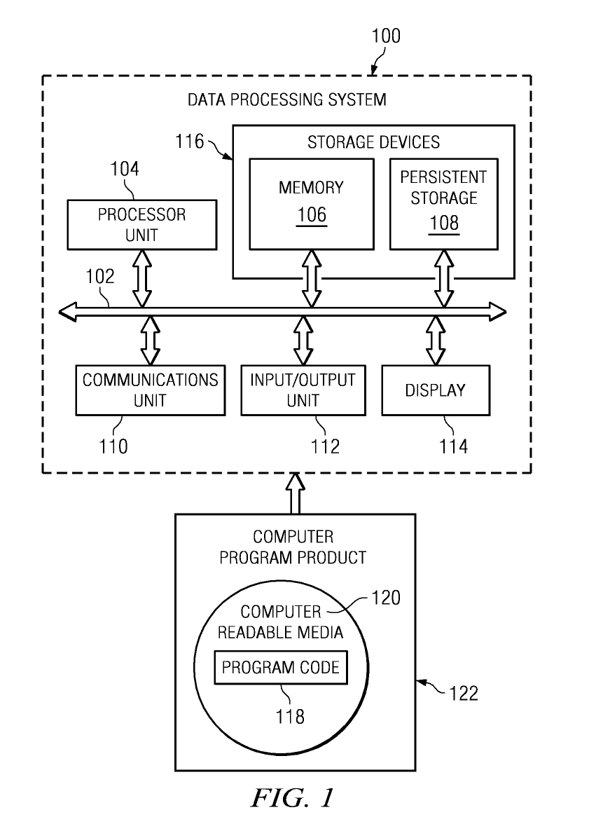

Turning now to FIG. 1, a diagram of a data processing system is depicted in accordance with an illustrative embodiment. In this illustrative example, data processing system 100 includes communications fabric 102, which provides communications between processor unit 104, memory 106, persistent storage 108, communications unit 110, input/output (I/O) unit 112, and display 114.

Processor unit 104 serves to execute instructions for software that may be loaded into memory 106. Processor unit 104 may be a set of one or more processors or may be a multi-processor core, depending on the particular implementation. Further, processor unit 104 may be implemented using one or more heterogeneous processor systems in which a main processor is present with secondary processors on a single chip. As another illustrative example, processor unit 104 may be a symmetric multi-processor system containing multiple processors of the same type.

Memory 106 and persistent storage 108 are examples of storage devices 116. A storage device is any piece of hardware that is capable of storing information, such as, for example without limitation, data, program code in functional form, and/or other suitable information either on a temporary basis and/or a permanent basis. Memory 106, in these examples, may be, for example, a random access memory or any other suitable volatile or non-volatile storage device. Persistent storage 108 may take various forms depending on the particular implementation. For example, persistent storage 108 may contain one or more components or devices. For example, persistent storage 108 may be a hard drive, a flash memory, a rewritable optical disk, a rewritable magnetic tape, or some combination of the above. The media used by persistent storage 108 also may be removable. For example, a removable hard drive may be used for persistent storage 108.

Communications unit 110, in these examples, provides for communications with other data processing systems or devices. In these examples, communications unit 110 is a network interface card. Communications unit 110 may provide communications through the use of either or both physical and wireless communications links.

Input/output unit 112 allows for input and output of data with other devices that may be connected to data processing system 100. For example, input/output unit 112 may provide a connection for user input through a keyboard, a mouse, and/or some other suitable input device. Further, input/output unit 112 may send output to a printer. Display 114 provides a mechanism to display information to a user.

Instructions for the operating system, applications and/or programs may be located in storage devices 116, which are in communication with processor unit 104 through communications fabric 102. In these illustrative examples, the instructions are in a functional form on persistent storage 108. These instructions may be loaded into memory 106 for execution by processor unit 104. The processes of the different embodiments may be performed by processor unit 104 using computer-implemented instructions, which may be located in a memory, such as memory 106.

These instructions are referred to as program code, computer-usable program code, or computer-readable program code that may be read and executed by a processor in processor unit 104. The program code in the different embodiments may be embodied on different physical or tangible computer-readable media, such as memory 106 or persistent storage 108.

Program code 118 is located in a functional form on computer-readable media 120 that is selectively removable and may be loaded onto or transferred to data processing system 100 for execution by processor unit 104. Program code 118 and computer-readable media 120 form computer program product 122 in these examples. In one example, computer-readable media 120 may be in a tangible form, such as, for example, an optical or magnetic disc that is inserted or placed into a drive or other device that is part of persistent storage 108 for transfer onto a storage device, such as a hard drive that is part of persistent storage 108. In a tangible form, computer-readable media 120 also may take the form of a persistent storage, such as a hard drive, a thumb drive, or a flash memory that is connected to data processing system 100. The tangible form of computer-readable media 120 is also referred to as computer-recordable storage media. In some instances, computer-readable media 120 may not be removable.

Alternatively, program code 118 may be transferred to data processing system 100 from computer-readable media 120 through a communications link to communications unit 110 and/or through a connection to input/output unit 112. The communications link and/or the connection may be physical or wireless in the illustrative examples. The computer-readable media also may take the form of non-tangible media, such as communications links or wireless transmissions containing the program code.

In some illustrative embodiments, program code 118 may be downloaded over a network to persistent storage 108 from another device or data processing system for use within data processing system 100. For instance, program code stored in a computer-readable storage medium in a server data processing system may be downloaded over a network from the server to data processing system 100. The data processing system providing program code 118 may be a server computer, a client computer, or some other device capable of storing and transmitting program code 118.

The different components illustrated for data processing system 100 are not meant to provide architectural limitations to the manner in which different embodiments may be implemented. The different illustrative embodiments may be implemented in a data processing system including components in addition to or in place of those illustrated for data processing system 100. Other components shown in FIG. 1 can be varied from the illustrative examples shown. The different embodiments may be implemented using any hardware device or system capable of executing program code. As one example, the data processing system may include organic components integrated with inorganic components and/or may be comprised entirely of organic components excluding a human being. For example, a storage device may be comprised of an organic semiconductor.

As another example, a storage device in data processing system 100 is any hardware apparatus that may store data. Memory 106, persistent storage 108 and computer-readable media 120 are examples of storage devices in a tangible form.

In another example, a bus system may be used to implement communications fabric 102 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 106 or a cache such as found in an interface and memory controller hub that may be present in communications fabric 102.

Data processing system 100, for example, provides an illustrative embodiment in which is identified a subset of the data from a proposal repository may be formed and maintained in storage devices 116. The subset of the proposal repository or database is then processed by processor unit 104 in accordance with selected compliance models retrieved from storage devices 116 to form an analyzed subset of proposals. Forming the analyzed subset of proposals, with compliance, may then produce alert instances that are communicated by communications unit 110, input/output unit 112 or display 114 to specified users, as user updates for further action. User updates typically provide a user interest defined subset of the analyzed subset of proposals. Reports are also produced from the alert instances of the analyzed subset of proposals. For example, the reports may list product offerings that are no longer used. The report may then be further processed to remove the listed product offerings from the product offering catalog maintained in storage devices 116.

Alternate embodiments can be applied to other domains as well. For example, the analysis of the subset of proposals may be used to create alerts in domains such as materials planning and parts sourcing. The alerts may then initiate other action in the respective domains.

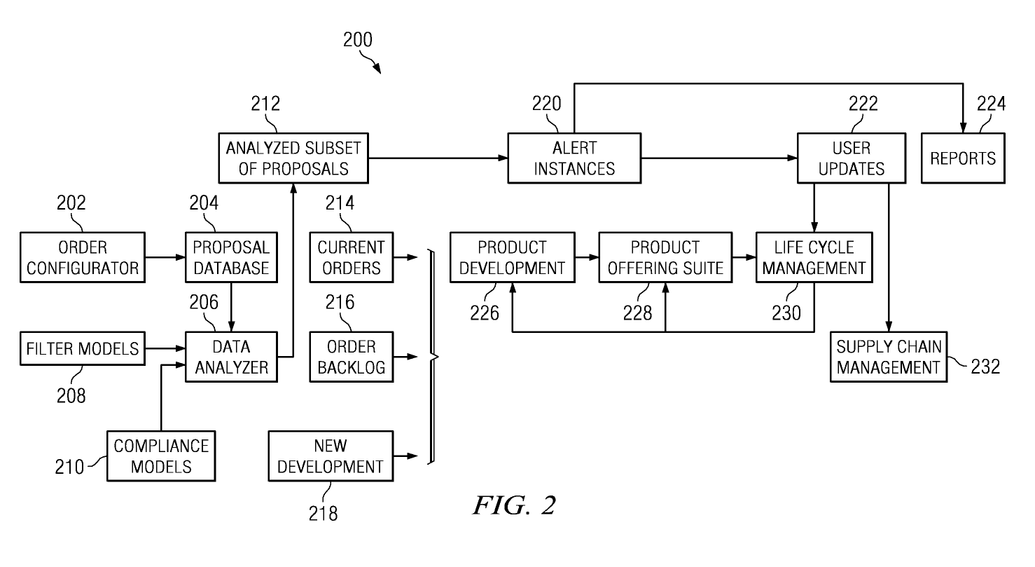

With reference to FIG. 2, a block diagram of an overview of a product offering management process in accordance with an illustrative embodiment is presented. The embodiment depicted uses proposal database 204 to mine and interpret useful information that will help in trimming product offering suite 228.

Order configurator 202 provides a capability to allow users to enter configuration data for a desired product configuration that once captured, is maintained in proposal database 204. Typical configurator input is provided through a graphical user interface supported by the underlying data processing system. Proposal database 204 contains information from an historical perspective, as well as more recent information collected through input from proposals of order configurator 202.

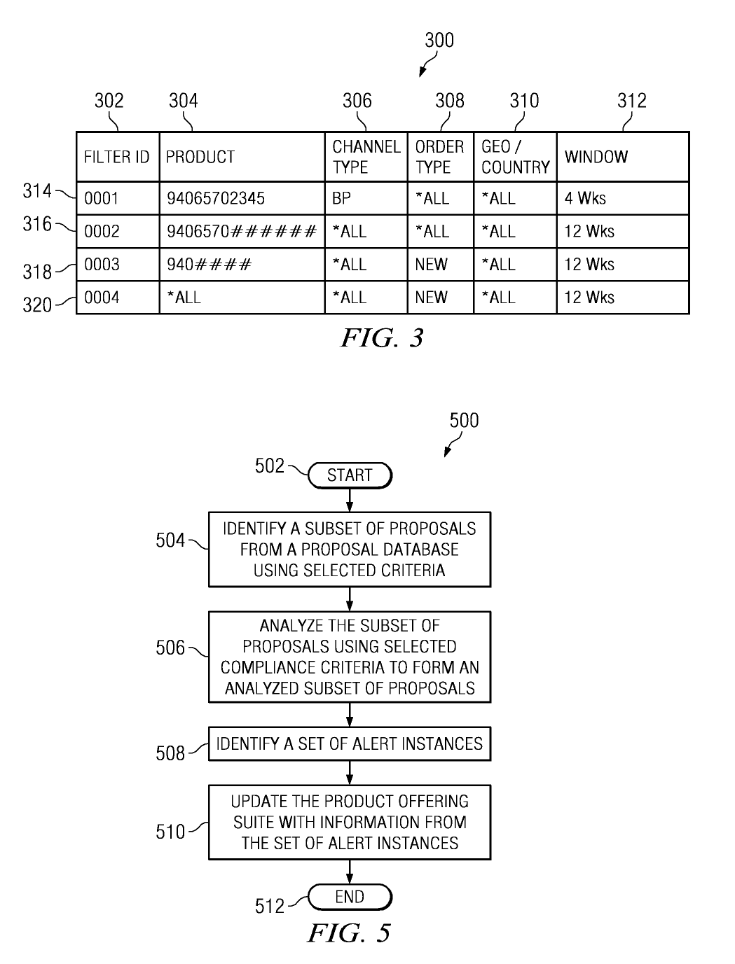

Filter models 208 are used by data analyzer 206 to reduce the number of proposals to be analyzed from proposal database 204. Filtering is a process of data analyzer 206 that selects entries in proposal database 204 according to the criteria provided in filter models 208. Filter models 208 provides a programmatic mechanism to specify which data is to be analyzed. Instead of analyzing all of the data contained in proposal database 204, a subset may be defined. Filtering thus reduces the data to be analyzed and therefore reduces time to process the data. For example, applying a time filter such as “this quarter” to proposal database 204 produces a resultant time-phased repository having only data related to this quarter. An example of a set of filters appears in FIG. 3.

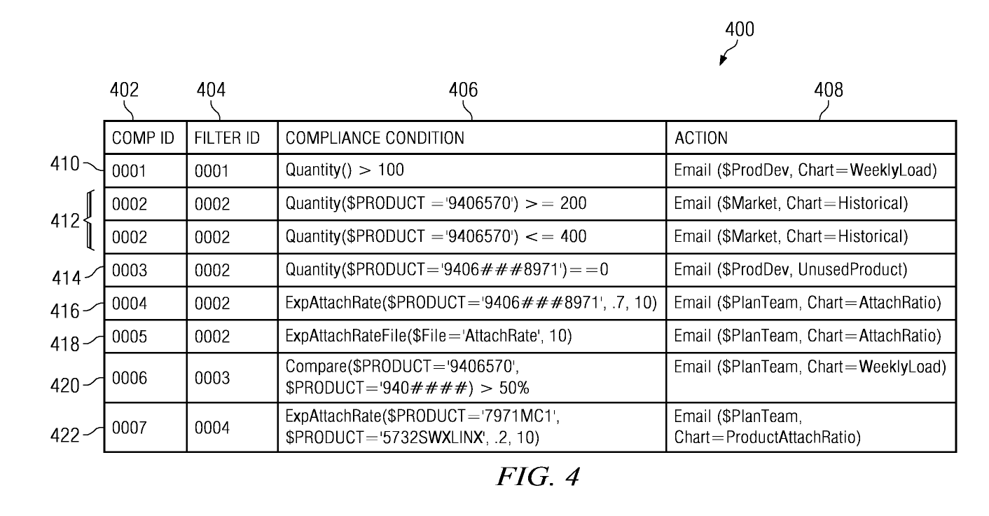

Data analyzer 206 further processes the subset of data identified by filtering. Analysis is performed using compliance models 210. An entry in the set of entries of the compliance models includes criteria against which compliance is measured. Actions are specified to occur as a result of matching or meeting a compliance condition. Compliance models 210 may be rules specified in a simple form of a condition and action. When the condition is met, the action is performed. An example of a set of compliance models appears in FIG. 4.

Current orders 214, order backlog 216 and new development 218 provide alternative input sources for product offerings to enter process 200. Current orders 214 provides the most recent form of requests for product offerings. Order backlog 216 provides a representation of previously ordered but unfulfilled product offerings. New development 218 provides a set of product offerings that may or may not relate to current orders 214 and order backlog 216. A mismatch may occur when customer requirements and new development output produce differing results.

Product development 226 is a function that provides the marketable output in response to the requirements from the input sources just described. Products from product development 218 are then listed in product offering suite 228. Product offering suite 228 provides a detailed listing of the various products available to customers and may be implemented as a set of computer-implemented databases.

Life cycle management 230 provides a capability to manage the product through various stages of the life of a product from product inception to withdrawal. For example, a product may be developed in response to a customer requirement, resulting in a prototype. The prototype may be reviewed and refined into a marketable product. The product evolves through a number of releases and is eventually replaced with a new product. Life cycle management 230 provides management of the product through the different stages and iterations until the product is replaced. Each stage in the product life may require information to be developed and maintained with respect to product-specific data, marketing, and promotion as well as legal and safety-related aspects.

Information related to order configurations for new products in the form of a proposal database or repository is maintained in a proposal database 204. Configuration information specific to an instance of a product that is proposed is captured and stored in proposal database 204. Typically, the information is not reused in subsequent stages of process 200. Information from proposal database 204 may be reflected only in current orders 214. Proposals that do not result in an order are rarely materialized in process 200.

The example shown provides proposal information as analyzed subset of proposals 212 that can be used by life cycle management 230 and other components to trim product offering suite 228. Analyzed subset of proposals 212 is available before orders are placed and is a leading indicator of orders that will be placed in an upcoming cycle. The materials and manufacturing teams may fine-tune their planning based on the new output determined using analyzed subset of proposals 212. This new data in analyzed subset of proposals 212 typically enables companies to make decisions faster and, in particular, trim bloated product offering catalogs to reflect offerings that are being proposed through the ordering tools. Analyzed subset of proposals 212 is an example of a filtered and analyzed set of information derived from the complete proposal database 204.

Process 200 also provides a capability to model and therefore refine offering data received through order configurator 202 into proposal database 204 by data analyzer 206. Compliance indicators produced through the analysis enable automated monitoring of order “proposals” in real-time, while measuring the compliance. When compliance thresholds are encountered, process 200 provides a capability to initiate a series of actions in response to the particular situation encountered. Compliance indicators are used to reflect conditional processing of proposal database 204 into analyzed subset of proposals 212. For example, a condition may be set to cause an alert if less than a predefined number of a specific product is ordered within a specified time period. This example may be used to confirm a test market activity for the specific product.

The data of analyzed subset of proposals 212 identifies product offerings that are being proposed as well as product offerings that are not being proposed. The data for items not being proposed may be comprised of configuration output that was modeled by a customer but never ordered or implemented. Alert instances 220 is an example of information generated through data analyzer 206 of process 200. The information provides the intelligence needed to trim a bloated product offering catalog, such as product offering suite 228. Process 200 typically provides a capability for better planning of new product offerings, reducing the cost of inventory/procurement in the area of supply chain management 232 by optimizing the product offering suite. Improved utilization of manufacturing and testing resources typically leads to an improvement in a company's ability to create product offerings that are marketable.

Illustrative embodiments of process 200 thus provide for a subset of the data from a proposal repository such as proposal database 204 to be formed. The subset may be generated based on filtering according to selection criteria of a product family such as all machines of type “x” or may be specified as a set of products within in defined time period. The selected subset is then processed in accordance with selected compliance models using data analyzer 206 to form a set of compliant proposals of analyzed subset of proposals 212. Compliance models provide a capability to selectively apply predetermined combinations of conditions and actions to members of the subset of proposals. A compliance model is typically specified in the form of a condition and associated action. For example, “when machine type=X, and feature=y, create a list; email to ProdAdminId” would cause a listing of all machines of type ‘X’ having feature ‘y’ sent to the email address of ProdAdminID for further action.

Forming the set of compliant proposals may produce a set of alert instances that are communicated to specified users as user updates 222 for further action. Alert instances are created from the conditional processing of the filtered proposals using the compliance models. User updates 222 are a subset of the alert instances that may be of interest to the users. Reports 224 are also produced from alert instances 220 and user updates 222 to further refine product offering suite 228.

For example, as a result of data analysis performed by data analyzer 206, product proposals for offerings may be identified that were never manufactured or formally requested. These offerings are typically never added to a shopping cart in order configurator 202, but may have been visited, and examined by customers but not completed as orders.

Offerings may also be identified that were proposed outside an expected range compared to an anticipated number of proposals for the offering. For example, a predefined configuration for a product offering may include a specific number of elements, such as four disk drives, but a customer configured an instance with twenty disk drives.

In another example, identification of offerings proposed in low or high numbers as compared to other equivalent offerings is made, and the comparison may be reflected in absolute terms of raw numbers and/or percentages. In another example, proposal counts may be computed in the context of integrated or associated content behavior referred to as “attach rates.” For example, when purchasing a bicycle frame, there is a need for two wheels. Therefore, the attach rate of wheels to frames is two to one.

The data analysis may also highlight the differences of geographically-specific market acceptance of offerings, reveal trends of offering acceptance over a pre-specified time period, and detect specific, complex scenarios involving one or more products proposed by specific market segments. For example, a new product is selling well in the north-east but sales are sluggish for the same product in the south-west. In another example, a new product offering may be tracked to determine market acceptance by month or quarter.

Reports are provided as output from the filtering and analyzing in the form of historical reports 224. The reports may be predefined or tailored reports as required by a report generation facility included with the system, or as an additional component of reports 224. Reports typically include anomalies detected as a result of applying compliance models 210 to the filtered proposal data created by using filter models 208. For example, a report may be produced to list all products without sales in a specific period. In another example, a report may be created for products that have been proposed but never ordered.

A notification capability makes selected or subscribed users aware of the results of the analysis in the form of user updates 222. Alert instances 220 are created by the analysis of the proposal database 204 which are further processed to create user updates 222. Notification is typically provided as synchronous or asynchronous notification in a variety of forms selected by an implementation. For example, user updates 222 can be used to update product offering suite 228. The updates cause the content of product offering suite 228 to be updated to reflect the requirements collected from the customer by way of the proposal database 204.

Notification methods include messaging on the data processing system, alerts, and email providing information in list, table, chart and additional display forms. Transformation services may also be used to distribute notification messages to devices, such as cellular phones, personal digital assistants and other systems remote to the data processing system, in communication with the data processing system on which the notification is initiated. For example, an alert may be sent to a cellular phone of a user in the form of a text message. In another example, a chart, which may be a tabular list, could be sent to a smart phone personal digital assistant displaying a number of items.

Efficiency of managing the product offerings, including items such as announcements and withdrawals, is typically improved by dynamically trimming or filtering the offerings based on continuous feedback from the database of proposal database 204. The order proposals created by users, partners, and sales engineers are available in a central repository because of the advent of web-based order configurators, such as order configurator 202. While all of the proposals may not be converted into confirmed orders, the proposals created daily are a good indication of what types of products and product contents will eventually appear in future orders.

By leveraging information from order proposals that are in process, the current product offering catalog, such as product offering suite 228, can be trimmed or modified. Typically, the rarely configured products can be withdrawn while the more popular products can be well-stocked. Also, based on modifications to the existing standard configurations, new product offerings can be more easily designed and announced.

With reference to FIG. 3, a tabular representation of a data structure containing filtering models for use with the product offering management system of FIG. 2 is presented, in accordance with an illustrative embodiment. Filtering models 300 is an example of filter models 208 of FIG. 2 as may be used in filtering. In the example of FIG. 3, filtering models 300 is shown in a tabular form but may be implemented in other suitable formats as well including comma separated values and sets of parameter values.

Header 302 represents the filter identifier or “filter id” value of the particular filter model. The filter identifier is a handy, short form, unique reference to the filter model content. Header 304 represents the product entry value. The product entry may be specific to a part of a product or a product itself. Header 306 represents the channel type value used to distribute the product offering to market. A channel type may be specific type or all types of channels. Header 308 represents an order type value. The value may be specific order type or all types of orders. For example, an order type may be referred to as all, new, or upgrade. Header 310 represents a geographic or country value, identifying a region where the product is marketed. Again, the value may be specific to a geographical area or all geographies. Window 312 represents a time span or duration of time in which the data applies. For example, collect data for the window covering a period of the previous two weeks.

Using the data of the example of filtering models 300, row 314 represents a filter having a filter identifier of 0001 identifying a specific product identifier of 9406-570, in this case having a feature code of 2345 orders only from a channel type of business partners on a worldwide basis or all geographies within the previous 4 weeks.

Row 316 represents a filter identifier of 0002 identifying a product identifier of 9406-570 orders, regardless of features, from a channel type of all on a worldwide basis or all geographies within the previous 12 weeks.

Row 318 represents a filter identifier of 0003 identifying a product identifier of 940x, indicating any machine type beginning with 940 for new orders only from a channel type of all on a worldwide basis or all geographies within the previous 12 weeks.

Row 320 represents a filter identifier of 0004 identifying all product new orders only from a channel type of all on a worldwide basis or all geographies within the previous 12 weeks.

Filtering models provides a capability of specifying which set of data should be considered for analysis. Rather than analyzing every piece of data which may be an ineffective and lengthy process, only a subset of the product information in the proposal database 204 of FIG. 2 needs to be examined from different business perspectives. Application of the filtering models provides data reduction to reduce the processing time required for analysis.

With reference to FIG. 4, a tabular representation of a data structure containing compliance models for use with the product offering management process of FIG. 2 is presented, in accordance with an illustrative embodiment.

Compliance models 400 is an example of compliance models 210 of process 200 of FIG. 2. Compliance models 400 provides a capability of identifying compliance with a criteria specified. An entry in the compliance model defines a relationship between a filter model, a compliance condition and an action to perform when the compliance condition is matched. Therefore, an entry defines conformance criteria.

Header 402 represents the compliance identifier, Comp Id indicating a unique value for a compliance model instance. Header 404 represents the filter identifier, Filter ID that identifies the filtered data, or subset of proposal database 204 of FIG. 2 that the compliance conditions will be applied against. Header 406 represents the compliance condition to be used. In this illustrative example, the Compliance Condition is the criteria specified for a business objective. One or more conditions may be used, comprising a set of compliance conditions. Examples of supported conditions typically include specification in the form of Quantity(arg1) expression int argument supported $PRODUCT=‘mmmmMMMfff’ where mmmm=Machine Type, MMM=Model, ffff=Feature. The expression may include operators such as ‘==’, ‘<=’, ‘>=’, ‘̂=’. In another example, a condition may specify an attachment as ExpAttachRate(product, expectedAR, Tolerance, in which product is a specific product identifier, expectedAR is the expected attachment rate and Tolerance specifies an allowance of deviation from the attachment rate. Other condition forms may be user defined. Header 408 represents the Action that is to be performed as a result of meeting the specific compliance condition.

In the example of compliance models 400, row 410 indicates a Comp Id of 0001 defined to determine if the total quantity of items in the filter group 0001 has exceeded a threshold of 100. If the condition is met, then send the weekly order load chart by email to all representatives on the product development distribution list.

Rows 412 identifies a Comp Id of 0002 is defined to determine if the total quantity of items in the filter group 0002 includes machines of 9406-570 type is between 200 and 400. If both of the conditions are met, then send a chart of the order quantity by day to the Market e-mail list. When a compliance models have multiple compliance conditions, then each condition must be satisfied before the action can be taken.

Row 414 identifies a Comp Id of 0003 is defined using filter id of 0002 to determine if a specific feature 8971 associated with machine type 9406 has not been ordered. The action is to send an e-mail to the product development team including the entry on the unused product list.

Row 416 identifies Comp Id of 0004 is defined using filter id of 0002 to compare the attach ratio of feature 8971 against machine type 9406. If the attach ratio is not 0.7 with a plus or minus of 10%, then send an e-mail with that attach rate comparison to the planning team.

Row 418 identifies a Comp Id of 0005 is defined using filter id of 0002 to determine use of products with associated attach rates defined in a external file. Each product defined in the file with an attach rate outside the tolerance 10 defined would result in a compliance failure. Thus, a notification will be sent to the planning team with the attach ratio found, expected attach rate, and deviation.

Row 420 identifies a Comp Id of 0006 is defined using filter id of 0004 to determine the attach rate of Product 2 against Product 1 and compare against an expected rate of 0.2 with a tolerance of plus or minus 10%. If the condition is met, an email will be sent to the planning team distribution list with the product attach rate charts.

Row 422 identifies a Comp Id of 0007 is defined using filter id of 0003 to determine if a ratio of specific machines 9406570 to all machines of type 940x is greater than 50%. If the condition is met, send an email to planning team with a chart indicating the weekly load.

With reference to FIG. 5, a flowchart of a high level view of the product offering management process of FIG. 2, in accordance with an illustrative embodiment is presented. Process 500 is an example of the product offering management process 200 of FIG. 2.

Process 500 starts (step 502) and identifies a subset of proposals from a proposal database using selected criteria (step 504). For example, filtering criteria, as previously shown FIG. 3, is used to reduce the amount of data to be further analyzed by identifying a subset of the proposal data that is to be further processed. The subset of proposals is a result of filtering according to provided selection criteria of the filters. Filtering may also include techniques including aging, inclusive selection, and exclusive selection to reduce the larger proposal database information to a desired subset of proposals containing target data.

Process 500 analyzes the subset of proposals using selected compliance criteria for form an analyzed subset of proposals (step 506). The analyzed subset of proposals has been filtered from the data of the proposal database and analyzed with respect to compliance models as in FIG. 4.

Process 500 identifies a set of alert instances (step 508). The set of alert instances represents the reduction of the proposal database information to form a target set of data including desired elements of interest. For example, a set of data describing all machines of a specified type sold within a specified time frame. The set of alert instances may be further processed to create information specific to users.

Process 500 updates the product offering suite with information from the set of alert instances (step 510) with process 500 terminating thereafter (step 512). The user updates represent specific information for a user derived from the set of alert instances. In the previous example of a set of data describing all machines of a specified type sold within a specified time frame, some machines may not have been sold. A user may have indicated an interest in this anomaly or exception. The interested user would then receive a user update indicating the information for unsold machines. The product offering suite is then updated by removing the machines.

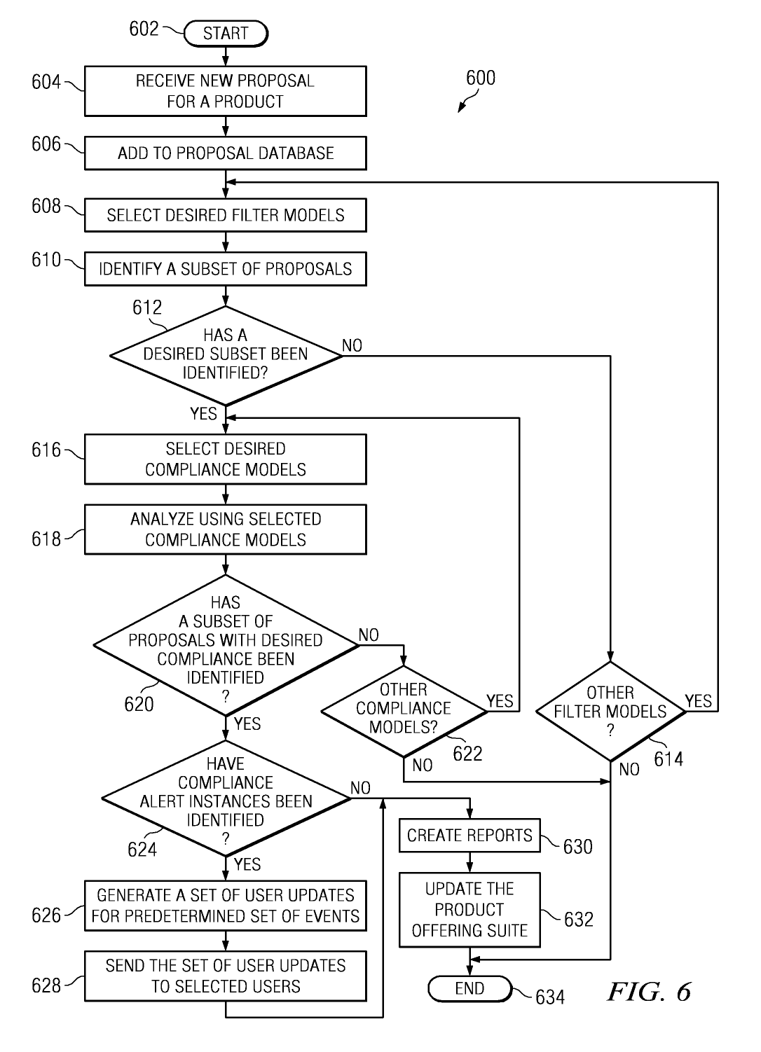

With reference to FIG. 6, a flowchart of a detailed view the product offering management process of FIG. 5 is presented, in accordance with an illustrative embodiment. Process 600 is an example of product offering management process 200 of FIG. 2.

Process 600 starts (step 602) and receives a new proposal for a product (step 604). The new proposal typically is initiated by a user and generated by and output from a proposal configurator such as proposal order configurator 202 of FIG. 2. The new proposal is added to the proposal database (step 606). The proposal repository stores the proposals in a persistent storage medium of the data processing system for a predefined period of time or determination based on a set of conditions.

Process 600 selects a set of desired filter models from a set of available filter models (step 608). A set, as used herein, comprises one or more members. Process 600 identifies a subset of proposals, using the selected filter models from step 608, from the proposal database to eliminate processing of unnecessary data (step 610). The amount of data to be later analyzed is thereby reduced to a selected subset of the proposal database. A determination is made as to whether a desired subset of the proposal database has been identified (step 612). If a desired subset has been identified, a “yes” result is obtained. If a desired subset has not been identified, a “no” result is obtained. When a “no” is obtained in step 612, a further determination is made as to whether other filter models are available and are applicable (step 614). If other filter models are available and applicable, a “yes” result is obtained and process 600 selects a set of other filter models moves to step 608. If there are no other available and applicable filter models, a “no” result is obtained and process 600 skips to step 634.

When a “yes” is obtained in step 612, process 600 selects a set of desired compliance models (step 616). Process 600 analyzes the subset of data using the selected set of desired compliance models from step 616 (step 618). Analysis is a form of conditional processing of the subset of data that result in identifying data of interest. The data of interest may materialize as an exception report or as a list of specific items requiring further action. In these illustrative examples, analysis uses entries in a compliance model that defines a relationship between a filter model, a compliance condition and an action to perform when the compliance condition is matched. For example, analysis of filtered data is performed to determine whether a compliance condition is matched. The resulting match causes an associated action to be performed. In an example, an entry in the compliance model determines if the total quantity of items in the filter group “A” has exceeded a threshold of “B.” If the condition is met, then send the weekly order load chart by email to all representatives on the product development distribution list. A compliance model may have multiple compliance conditions, wherein each condition must be satisfied before the action can be taken. Analysis, using the set of desired compliance models, of the subset of proposals forms a compliant subset of proposals.

Process 600 determines whether a subset of proposals with desired compliance has been identified (step 620). If a subset of proposals with desired compliance has been identified, a “yes” result is obtained. If a subset of proposals with desired compliance has not been identified, a “no” result is obtained. When a “no” is obtained in step 620, a further determination is made as to whether other compliance models are available and are applicable (step 622). If other compliance models are available and applicable, a “yes” result is obtained. Process 600 further determines whether a set of desired other compliance models exists. If a set of desired other compliance models exists, a “yes” result occurs and process 600 returns to step 616. If there are no other available and applicable compliance models, a “no” result is obtained and process 600 skips to step 634.

When a “yes” is obtained in step 620, a determination as to whether compliance alert instances have been identified (step 624). Compliant alert instances associated with the identified product proposals result from applying the compliance conditions and related actions to the subset of product proposal data. For example, compliant alert instances may be shown as entries in an exception report for a query of the subset of proposals to identify all product “X” having sales in the current quarter below level “Y.” Compliance conditions are applied and associated actions are performed during analysis of the filtered subset of proposals. The condition processing during analysis is an application of the compliance model rules to the filtered data of the subset of proposals.

If compliance alert instances have been identified, a “yes” result is obtained. If compliance alert instances have not been identified, a “no” result is obtained. When a “no” result is obtained in step 624, process 600 creates a set of reports based on the compliance results (step 630). Reports provide information for historical purposes and provide input for trimming the proposal database. For example, a report may provide a list of products such as a machine type that has not been ordered and is therefore deemed to be an unused product. The list then forms a “trim list” to delete the machine from the product offering catalog and eliminate associated resources that may have been wasted as a result of carrying the unused product. Reports may then be used to update the product offering repository suite (step 632), with process 600 terminating thereafter (step 634).

If a “yes” is obtained in step 624, process 600 generates a set of user updates for a predetermined set of events from the compliance alert instances (step 626). Generation of user updates for a predetermined set of events from the identified compliance alert instances creates a set of messages or notices related to the specific circumstances of the proposal database information. The predetermined set of events is a set of one or more events for which actions are to be taken. Events for which no actions are required or desired will typically be reported. Events for which actions are to be taken are typically events of interest in the form of anomalies that lead to product offering suite changes. For example, an alert may be issued for a product that has not been ordered for a predetermined period of time, causing a delete action to be associated with the alert instance and event. Having generated the compliance alert instances, the user updates are then sent to respective selected users by applicable communication methods (step 628). For example, a set of user updates may be communicated to a set of selected users for specified product areas by email. In another example, a user update may be issued to a product offering database administrator for the deletion of a no longer manufactured item.

Compliance alert instance processing includes sending the information for creation of reports of step 630. Reports may then be used to update the product offering suite (step 632), with process 600 terminating thereafter in step 634 as before. Updates reflect the results of the compliance model processing. The set of compliance alert instances comprises one or more compliance alert instances related to compliance processing of the filtered proposal data using the compliance models selected.

Illustrative embodiments thus provide for a subset of the data from a proposal repository to be formed. The subset is then processed in accordance with selected compliance models to form a set of proposals with rated compliance. Forming the subset of proposals with compliance may then produce alert instances that are communicated to specified users for further action. Reports are also produced from the alert instances of the subset of proposals. For example, the reports may list product offerings that are no longer used which can then be further processed for removal from the product offering catalog.

Alternate embodiments can be applied to other domains as well. For example, the analysis of the subset of proposals may be used to create alerts in domains such as the domain of materials planning and the domain of parts sourcing.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention, the practical application, and to enable others of ordinary skill in the art to understand the invention for various embodiments, with various modifications as are suited to the particular use contemplated.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by, or in connection with, a computer or any instruction execution system. For the purposes of this description, a computer-usable or computer-readable medium can be any tangible apparatus that can contain, store, communicate, propagate, or transport the program for use by, or in connection with, the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments, with various modifications as are suited to the particular use contemplated.

What is claimed is:

1. A computer-implemented method for maintaining a product offering suite; the computer-implemented method comprising:
identifying a subset of proposals from a proposal database maintained on a data processing system using selected criteria stored on the data processing system:
analyzing the subset of proposals using conformance criteria stored on the data processing system to form an analyzed subset of proposals;
identifying a set of alert instances from the analyzed subset of proposals; and
updating the product offering suite on the data processing system using information using the set of alert instances.

2. The computer-implemented method of claim 1, wherein the identifying a subset of proposals further comprises:
receiving a new product proposal from an order configurator; and
adding the new product proposal to maintain the proposal database.

3. The computer-implemented method of claim 1, wherein the identifying a subset of proposals further comprises:
selecting a set of desired filter models from a set of filter models; and,
applying the set of desired filter models to the proposal database.

4. The computer-implemented method of claim 1, wherein the identifying a subset of proposals further comprises:
determining whether the subset of proposals is a desired subset;
responsive to a determination that the subset of proposals is not the desired subset, determining whether other filter models exist;
responsive to a determination that other filter models exist, selecting a set of filter models from the other filter models to form a selection of filter models; and
applying the selection of filter models to the proposal database.

5. The computer-implemented method of claim 1, wherein the analyzing the subset of proposals further comprises:
selecting a set of desired compliance models from a set of compliance models; and
applying the set of desired compliance models to the subset of proposals to form the analyzed subset of proposals.

6. The computer-implemented method of claim 1, wherein the identifying a set of alert instances further comprises:
determining whether a subset of proposals with desired compliance has been identified;
responsive to a determination that the subset of proposals with desired compliance has not been identified, determining whether other compliance models exist;
responsive to a determination that other compliance models exist, selecting a set of compliance models from the other compliance models to form a selection of other compliance models; and
applying the selection of other compliance models to the subset of proposals.

7. The computer-implemented method of claim 1, wherein the identifying a set of alert instances further comprises:
responsive to determining compliance alerts have not been identified, creating a set of reports;
responsive to determining compliance alerts have been identified, generating a set of user updates for a predetermined set of events of interest from the set of alert instances; and
sending the set of user updates to selected users.

8. An apparatus for maintaining a product offering suite; the apparatus comprising:
a communication fabric;
a storage device connected to the communication fabric, wherein the storage device stores computer-executable program code;
a communications unit connected to the communication fabric;
a display connected to the communication fabric;
a processor unit connected to the communication fabric, wherein the processor unit executes the computer-executable program code to direct the apparatus to:
identify a subset of proposals from a proposal database using selected criteria;
analyze the subset of proposals using conformance criteria to form an analyzed subset of proposals;
identify a set of alert instances from the analyzed subset of proposals; and
update the product offering suite using information using the set of alert instances.

9. The apparatus of claim 8, wherein in executing the program code to identify a subset of proposals, the processor unit executes the computer-executable program code to:
obtain a new product proposal from an order configurator; and
add the new product proposal to maintain the proposal database.

10. The apparatus of claim 8, wherein in executing the program code to identify a subset of proposals, the processor unit executes the computer-executable program code to:
select a set of desired filter models from a set of filter models; and
apply the set of desired filter models to the proposal database.

11. The apparatus of claim 8, wherein in executing the program code to identify a subset of proposals, the processor unit executes the computer-executable program code to:
determine whether the subset of proposals is a desired subset;
responsive to a determination that the subset of proposals is not the desired subset, determine whether other filter models exist;
responsive to a determination that other filter models exist, select a set of filter models from the other filter models to form a selection of filter models; and
apply the selection of filter models to the proposal database.

12. The apparatus of claim 8, wherein in executing the program code to analyze the subset of proposals, the processor unit executes the computer-executable program code to:
select a set of desired compliance models from a set of compliance models; and
apply the set of desired compliance models to the subset of proposals to form the analyzed subset of proposals.

13. The apparatus of claim 8, wherein in executing the program code to identify a set of alert instances, the processor unit executes the computer-executable program code to:
determine whether a subset of proposals with desired compliance has been identified;
responsive to a determination that the subset of proposals with desired compliance has not been identified, determine whether other compliance models exist;
responsive to a determination that other compliance models exist, select a set of compliance models from the other compliance models to form a selection of other compliance models; and
apply the selection of other compliance models to the subset of proposals.

14. The apparatus of claim 8, wherein in executing the program code to identify a set of alert instances, the processor unit executes the computer-executable program code to:
responsive to determining compliance alerts have not been identified, create a set of reports;
responsive to determining compliance alerts have been identified, generate a set of user updates for a predetermined set of events of interest from the set of alert instances; and
send the set of user updates to selected users.

15. A computer program product for maintaining a product offering suite; the computer program product comprising:
a computer-recordable storage media;
computer-executable program code, stored on the computer-recordable storage media, for identifying a subset of proposals from a proposal database using selected criteria;
computer-executable program code, stored on computer-recordable storage media, for analyzing the subset of proposals using conformance criteria to form an analyzed subset of proposals;
computer-executable program code, stored on computer-recordable storage media, for identifying a set of alert instances from the analyzed subset of proposals; and
computer-executable program code, stored on computer-recordable storage media, for updating the product offering suite using information using the set of alert instances.

16. The computer program product of claim 15, wherein the computer-executable program code, stored on the computer-recordable storage media, for identifying a subset of proposals further comprises:
computer-executable program code, stored on the computer-recordable storage media, for obtaining a new product proposal from an order configurator; and
computer-executable program code, stored on the computer-recordable storage media, for adding the new product proposal to maintain the proposal database.

17. The computer program product of claim 15, wherein computer-executable program code, stored on computer-recordable storage media, for identifying a subset of proposals further comprises:
computer-executable program code, stored on the computer-recordable storage media, for selecting a set of desired filter models from a set of filter models; and
computer-executable program code, stored on the computer-recordable storage media, for applying the set of desired filter models to the proposal database.

18. The computer program product of claim 15, wherein the computer-executable program code, stored on computer-recordable storage media, for identifying a subset of proposals further comprises:
computer-executable program code, stored on the computer-recordable storage media, for determining whether the subset of proposals is a desired subset;
computer-executable program code, stored on computer-recordable storage media, responsive to a determination that the subset of proposals is not the desired subset, for determining whether other filter models exist;
computer-executable program code, stored on the computer-recordable storage media, responsive to a determination that other filter models exist, for selecting a set of filter models from the other filter models to form a selection of filter models; and
computer-executable program code, stored on the computer-recordable storage media, for applying the selection of filter models to the proposal database.

19. The computer program product of claim 15, wherein computer-executable program code, stored on computer-recordable storage media, for analyzing the subset of proposals further comprises:
computer-executable program code, stored on computer-recordable storage media, for selecting a set of desired compliance models from a set of compliance models; and
computer-executable program code, stored on computer-recordable storage media, for applying the set of desired compliance models to the subset of proposals to form the analyzed subset of proposals.

20. The computer program product of claim 15, wherein computer-executable program code, stored on computer-recordable storage media, for identifying a set of alert instances further comprises:
computer-executable program code, stored on computer-recordable storage media, for determining whether a subset of proposals with desired compliance has been identified;
computer-executable program code, stored on computer-recordable storage media, responsive to a determination that the subset of proposals with desired compliance has not been identified, for determining whether other compliance models exist;
computer-executable program code, stored on computer-recordable storage media, responsive to a determination that other compliance models exist, for selecting a set of compliance models from the other compliance models to form a selection of other compliance models;
computer-executable program code, stored on computer-recordable storage media, for applying the selection of other compliance models to the subset of proposals;
computer-executable program code, stored on computer-recordable storage media, responsive to determining compliance alerts have not been identified, for creating a set of reports;
computer-executable program code, stored on computer-recordable storage media, responsive to determining compliance alerts have been identified, for generating a set of user updates for a predetermined set of events of interest from the set of alert instances; and
computer-executable program code, stored on computer-recordable storage media, for sending the set of user updates to selected users.

21. A service for maintaining a product offering suite, the service comprising:
identifying a subset of proposals from a proposal database maintained on a data processing system using selected criteria;
analyzing the subset of proposals using selected conformance criteria to form an analyzed subset of proposals;
identifying a set of alert instances from the analyzed subset of proposals; and
updating the product offering suite on the data processing system using information using the set of alert instances, for a user.
